(19) United States
(12) Patent Application Publication
(10) Pub. No.: US 2011/0240544 A1
(43) Pub. Date: Oct. 6, 2011

(54) APPARATUS FOR COLLECTING KIDNEY STONES

(76) Inventor: Terri J. Veach, Las Vegas, NV (US)

(21) Appl. No.: 12/751,033

(22) Filed: Mar. 31, 2010

(51) Int. Cl. B01D 35/28

(52) U.S. Cl. 210/238; 210/241

(57) ABSTRACT

An apparatus includes a frame having a top side including slots, a bottom side and a generally oval shape. A hollow protruding stem is joined to the frame. A mesh net is joined to, and is suspended below, the bottom side. The mesh net has a semi-circular shape with a sufficient porosity for freely passing urine and collecting stones in the mesh net. An elongated handle holds the mesh net while urinating for a user to avoid contacting the urine. The elongated handle includes an arched shape for facilitating use of the apparatus while sitting. An extending bulb is joined to a distal end of the elongated handle for insertion into the protruding stem. A splashguard has tabs for joining to the slots about a portion of the top for mitigating splash back upon the user. The portion is selected for right or left handed use of the apparatus.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to medical supplies. More particularly, the invention relates to a device for collecting kidney stones.

### BACKGROUND OF THE INVENTION

Millions of Americans deal with kidney stones every year, and the incident rate of kidney stones is rapidly growing due to dietary trends and environmental trends. Having a kidney stone is typically an unpleasant situation with symptoms including, general and constant pain about the groin and back, blood and pus in the urine, nausea, fever and chills, abdominal distention, a burning sensation while urinating, and a stabbing sensation so sharp and strong when the kidney stone finally passes that a study by the Mayo Clinic describes it to be “the worst pain ever experienced.” Furthermore, many persons who suffer these maladies must collect their kidney stones for lab analysis. The unsanitary, unhygienic process of gathering kidney stones adds significant insult to injury. After suffering such pain and discomfort, the person may have to dip his fingers into his own urine, and possibly blood and pus, to retrieve the kidney stone that caused it all. Collecting kidney stones can also be wasteful of the containers used to collect the kidney stones. If a household container is used, the person will often throw the container away. It is therefore an objective of the present invention to provide means for collecting kidney stones that is more sanitary and hygienic and does not require direct contact with the urine in which they are discharged.

Kidney stones are one of the oldest recorded medical conditions in all of medical history, and are even directly referred to in the ancient Hippocratic Oath. This is a well-known problem that has affected many for very many years. Unfortunately, it seems that the risk of kidney stones is now growing. In fact, the incidence rate of kidney stones in the United States grew 36.8 percent over the last 30 years. Today, one out of every six adult Americans will suffer from this condition, and this rate is likely to grow. One primary contributing factor to kidney stones is a lack of calcium. As more and more Americans find that they are prone to lactose intolerance, they stay away from milk and other dairy products resulting in less calcium in their diets. Ingesting less calcium increases the risk of kidney stone development. Another circumstance that may also lead to additional growth in kidney stone incidence in the United States is the current quality of tap waters. More and more environmental tests are finding high rates of cadmium in tap waters across the country, especially in areas near hazardous waste depositories and farms. This substance is used as a pigment in many plastics, which is why it winds up discarded in waste areas and is also present in farm-used fertilizers. The risk of kidney stones may be six times worse in areas where there is an increased presence of cadmium in the tap water. Testing on bottled water has found the same contaminants as well.

While devices designed to provide similar functions of collecting kidney stones are commercially available, there are no devices with the convenience, unique design, functionality, and methodology incorporated in preferred embodiments of the present invention. For example, without limitation, these currently available devices are typically cups or receptacles that collect urine in addition to kidney stones. When using these devices, the user must come into contact with the urine to remove the kidney stones from the urine. Also, when using these currently available devices, the user must typically keep their hands within range of the urinary discharge, which can be unsanitary.

In view of the foregoing, there is a need for improved techniques for providing means for easily collecting kidney stones in a sanitary manner.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B and 1C illustrate an exemplary kidney stone collector, in accordance with an embodiment of the present invention. FIG. 1A is a top perspective view. FIG. 1B is a diagrammatic top view, and FIG. 1C is a diagrammatic side view;

FIGS. 2A and 2B illustrate an exemplary use of an exemplary kidney stone collector, in accordance with an embodiment of the present invention. FIG. 2A is a top perspective view of the kidney stone collector in a collecting phase, and FIG. 2B is a top view of the kidney stone collector with collected kidney stones;

FIGS. 3A and 3B illustrate an exemplary kidney stone collector with a mesh net and a supporting frame that are detachable from a handle, in accordance with an embodiment of the present invention. FIG. 3A shows the kidney stone collector with the handle attached, and FIG. 3B shows the kidney stone collector with the handle detached;

FIG. 4 is a diagrammatic side view of an exemplary kidney stone collector with an ergonomic handle of an arched format, in accordance with an embodiment of the present invention; and

FIG. 5 is a top perspective view of an exemplary kidney stone collector that accommodates a urine splashguard, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for collecting kidney stones is presented.

In one embodiment an apparatus includes a frame including a top side, a bottom side and a generally oval shape, means joined to the bottom side for freely passing urine and collecting stones and means joined to the frame for holding the passing and collecting means while urinating, and for a user to avoid contacting the urine. Another embodiment further includes means for joining the elongated handle to the frame. Yet another embodiment further includes means joined to the holding means for insertion into the joining means. Still another embodiment further includes means joined to the top for mitigating splash back upon the user.

In another embodiment an apparatus includes a frame including a top side, a bottom side and a generally oval shape. A mesh net is joined to, and is suspended below, the bottom side. The mesh net has a sufficient porosity for freely passing urine and collecting stones in the mesh net. An elongated handle is joined to the frame for holding the mesh net while urinating, and for a user to avoid contacting the urine. In another embodiment the mesh net forms a semi-circular shape. Yet another embodiment further includes a protruding stem joined to the frame for joining the elongated handle to the frame. In still another embodiment the protruding stem is hollow. Another embodiment further includes an extending bulb joined to a distal end of the elongated handle for insertion into the protruding stem. In yet another embodiment the elongated handle is removable. In still other embodiments the elongated handle includes an ergonomic design for facilitating use of the apparatus while sitting and the elongated handle includes an arched shape. Another embodiment further includes a splashguard joined to the top for mitigating splash back upon the user. In yet another embodiment the splashguard extends upward from the top about a portion of the top. In still another embodiment the portion is selected for right or left handed use of the apparatus. In another embodiment the top further includes slots and the splashguard further includes tabs for joining to the slots. In yet another embodiment the splashguard is removable.

In another embodiment an apparatus includes a frame including a top side including slots, a bottom side and a generally oval shape. A hollow protruding stem is joined to the frame. A mesh net is joined to, and is suspended below, the bottom side. The mesh net has a semi-circular shape with a sufficient porosity for freely passing urine and collecting stones in the mesh net. An elongated handle holds the mesh net while urinating for a user to avoid contacting the urine. The elongated handle includes an ergonomic design having an arched shape for facilitating use of the apparatus while sitting. An extending bulb is joined to a distal end of the elongated handle for insertion into the protruding stem. A splashguard has tabs for joining to the slots and extending upward from the top about a portion of the top for mitigating splash back upon the user. The portion is selected for right or left handed use of the apparatus. In another embodiment the elongated handle is removable. In yet another embodiment the splashguard is removable.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a convenient, disposable and hygienic health tool, which can be manufactured in an environmentally respectful manner. Preferred embodiments comprise a mesh net, a frame that supports this mesh net, and a handle that projects from this frame. Each of these components is made of recycled and/or recyclable materials in preferred embodiments. Preferred embodiments are projected to be extremely cost-effective.

Preferred embodiments provide a sanitary means of collecting kidney stones during the passing process without the need of an additional receptacle. Preferred embodiments enable kidney stones to be collected without direct contact with urinary discharge. Preferred embodiments comprise a mesh net through which urine may pass while still retaining any kidney stones. Whereas kidney stones are ordinarily gathered within a cup or other receptacle, preferred embodiments generally eliminate the need for use of such receptacles including any cups, receptacles or other containers that are ordinarily used within a home. Therefore, preferred embodiments can preserve the use of those cups, receptacles and other containers so they are not eliminated from use, as would ordinarily happen should they be used to collect urine and kidney stones. Whereas typically used cups and receptacles also gather urine discharged, preferred embodiments collect no urine. Whereas kidney stones must ordinarily be removed from the urine that collects within typically used receptacles, preferred embodiments enable kidney stones to be removed with no direct contact with urine. Whereas users must ordinarily keep their hands within range of the urinary discharge, and are thus at high risk of direct contact with the urine being eliminated, preferred embodiments enable users to keep their hands at a safe and sanitary distance from the urinary discharge. Preferred embodiments are effectively designed for use by males and females. However, alternate embodiments may be made in separate formats specifically for male use and specifically for female use. Preferred embodiments of the present invention can help maintain the sanitary cleanliness of their using environments, as well. Whereas urine can easily splash about the area when collected in cups and other receptacles, preferred embodiments enable users to urinate in normal fashion and position, which can lower the risk of splashing and help protect the cleanliness of the using environment. By providing a sanitary method of kidney stone collection that enables users to urinate in a natural position, preferred embodiments may encourage greater compliance by persons in need of such medical attention, which can encourage better health and health awareness upon its users.

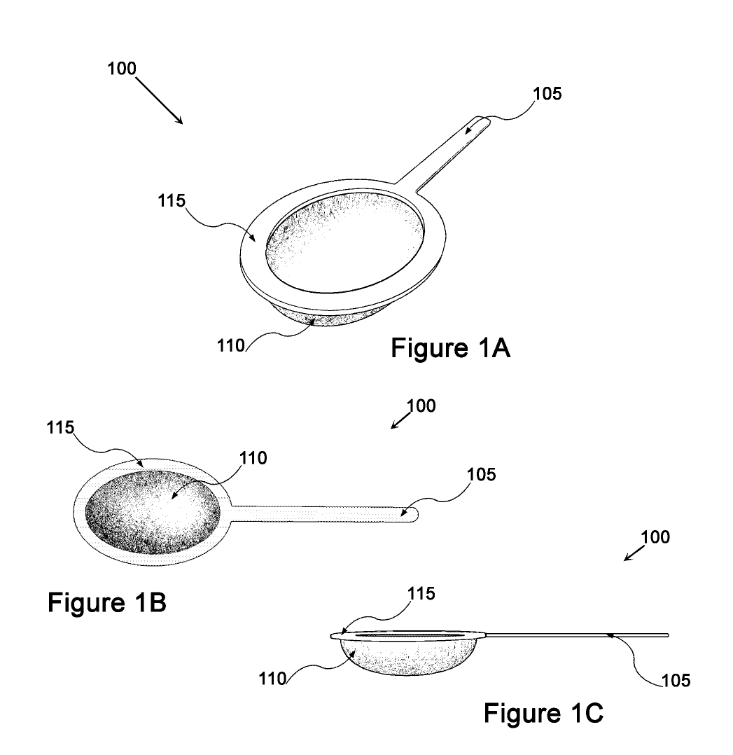

FIGS. 1A, 1B and 1C illustrate an exemplary kidney stone collector 100, in accordance with an embodiment of the present invention. FIG. 1A is a top perspective view. FIG. 1B is a diagrammatic top view, and FIG. 1C is a diagrammatic side view. In the present embodiment, kidney stone collector 100 comprises an elongated handle 105 supporting a mesh net 110 that can retain kidney stones ejected from the bladder without contact of urine upon the user. Mesh net 110, as well as a supporting frame 115 and extending handle 105 are preferably produced from recycled and/or recyclable materials. Handle 105 and frame 115 are preferably formed as a single unit using durable paperboard of recycled class as its principal material. In alternate embodiments, the frame and handle can be produced of various different applicable materials such as but not limited recycled/recyclable corrugated cardboard, recyclable and non-recyclable plastic materials such as but not limited to polyvinyl chloride (PVC) and high-density polyethylene (HDPE), various metals, or wood. In the present embodiment, frame 115 forms an oval shape four inches in length by two-and-one-half inches in width (4″×2½″), and handle 105 extends approximately six inches (6″) from frame 115. However, in alternate embodiments, kidney stone collectors may be made in various different sizes and shapes. In the present embodiment, mesh net 110 is of adequate porosity to enable urine to pass through while collecting kidney stones. Mesh net 110 is preferably made of a recycled polyester material in mesh format of size number sixty (#60) that has minimum porous space of ninety-seven thousandths of an inch (0.0097″). However, in alternate embodiments, the mesh net may be made of various different applicable materials, such as but not limited to recycled/recyclable polyester and recycled/recyclable paper. In other alternate embodiments, the mesh net may be made with non-recycled or non-recyclable materials, such as but not limited to polyvinyliden fluoride (PVDF). Furthermore, the mesh net in alternate embodiments may be of various different grades of density with various different pore sizes. In the present embodiment, mesh net 110 forms a semi-circular shape when attached to frame 115 from which it extends approximately three inches (3″) in depth. Mesh nets in alternate embodiments may vary in size and shape. For example, without limitation, some nets may have a funnel shape.

Kidney stone collectors according to the present embodiment are preferably packaged in quantities of twenty (20) units within a single container. However, kidney stone collectors may be packaged in various different quantities, including, but not limited to, individually. Kidney stone collectors may be packaged for retail sale to individual consumers or in packaging intended for distribution to hospitals, medical facilities and clinics. In some embodiments the kidney stone collector can bear various images, logos and designs upon its packaging or upon its self, including, but not limited to, those of registered trademark or copyright status.

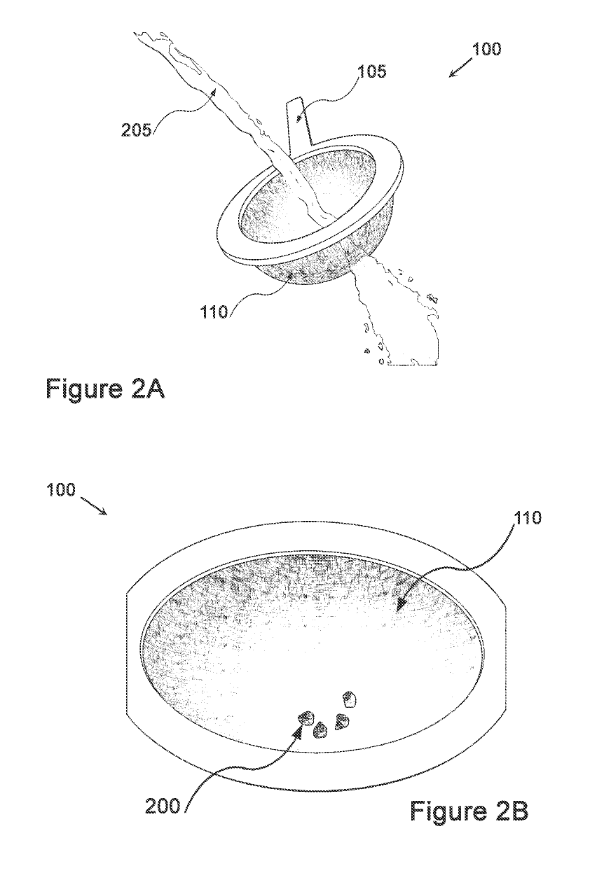

FIGS. 2A and 2B illustrate an exemplary use of an exemplary kidney stone collector 100, in accordance with an embodiment of the present invention. FIG. 2A is a top perspective view of kidney stone collector 100 in a collecting phase, and FIG. 2B is a top view of kidney stone collector 100 with collected kidney stones 200. In the present embodiment, while gripping a handle 105 of kidney stone collector 100, a user may position the device to generally keep a mesh net 110 in the area of a urine projection 205. Any kidney stones 200 passed with urine 205 are collected in mesh net 110 as urine 205 passes completely through mesh net 110. The user may then gather any kidney stones 200 collected for submittal to a doctor or medical laboratory. Kidney stone collector 200 may then be disposed of in a standard trash receptacle. Kidney stone collector 200 may also be used to collect struvite stones, uric acid stones and cystine stones in the same manner as kidney stones.

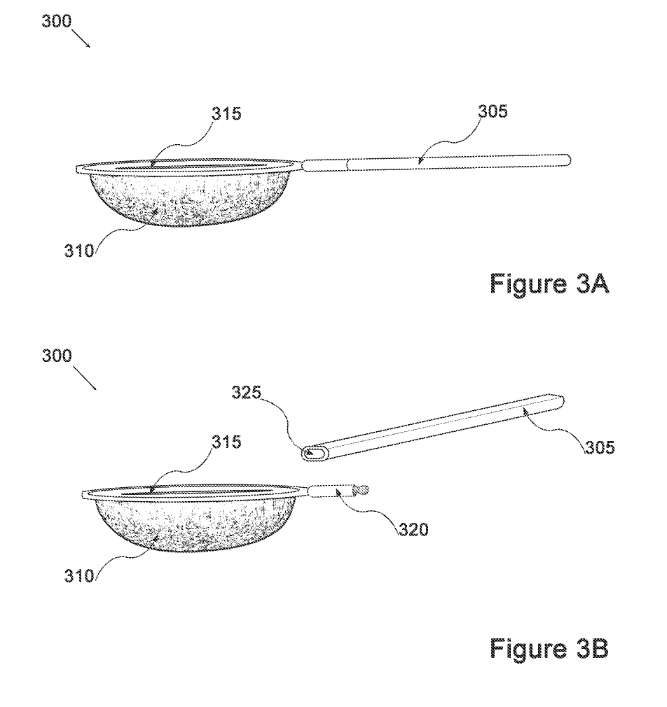

FIGS. 3A and 3B illustrate an exemplary kidney stone collector 300 with a mesh net 310 and a supporting frame 315 that are detachable from a handle 305, in accordance with an embodiment of the present invention. FIG. 3A shows kidney stone collector 300 with handle 305 attached, and FIG. 3B shows kidney stone collector 300 with handle 305 detached. In the present embodiment, extending from frame 315 of mesh net 310 is a short protruding stem 320 of hollow format. For insertion into this stem 320 is an extending bulb 325 protruding from the end of handle 305. Handle 305 is secured to frame 315 by pushing bulb 325 into hollow stem 320. With slight pressure mesh net 310 can be removed from handle 305. This enables a person to use one handle, which may be disposable or non-disposable, with many different disposable mesh nets. This can help to reduce landfill clutter. Those skilled in the art, in light of the present teachings, will readily recognize that the handle in alternate embodiments may be made detachable using various different means such as, but not limited to, sliding a hollow handle onto a stem on the frame, clips, screws, etc.

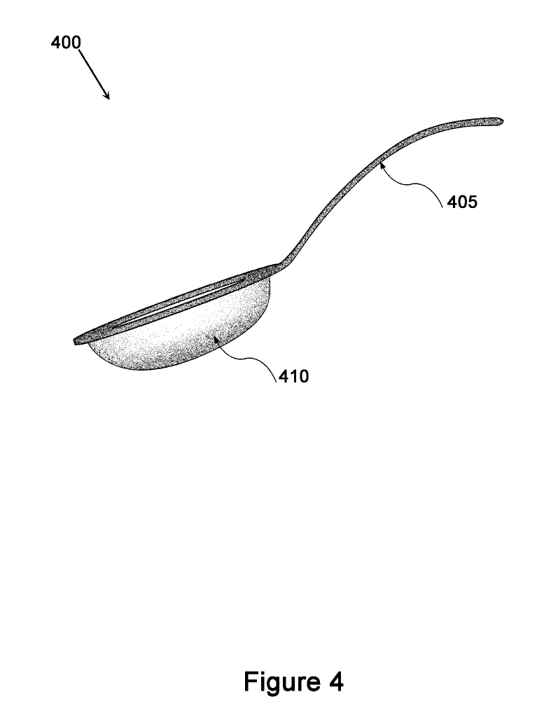

FIG. 4 is a diagrammatic side view of an exemplary kidney stone collector 400 with an ergonomic handle 405 of an arched format, in accordance with an embodiment of the present invention. The present embodiment, may make it easier for a person who is sitting on a toilet during urination to easily be able to place a mesh net 410 in the stream of urine. This embodiment is especially accommodating to women as they sit while urinating and can also be useful for men as passing a kidney stone is painful and they may need to sit while voiding. Alternate embodiments may incorporate various different ergonomic features such as, but not limited to, handles of different shapes and lengths, finger grips, flexible handles, extendable handles, etc.

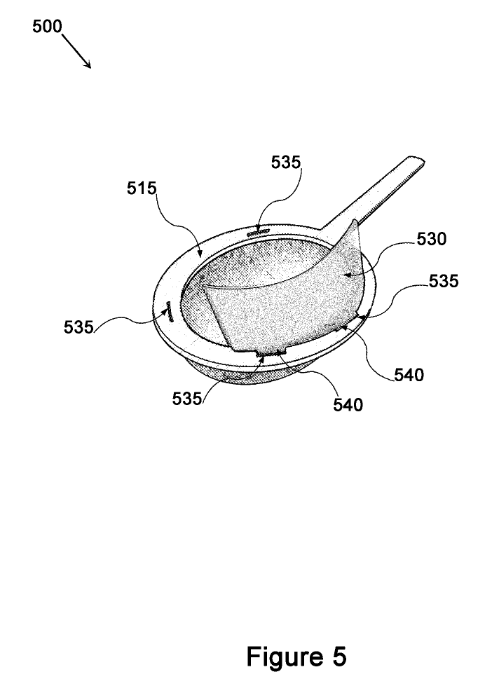

FIG. 5 is a top perspective view of an exemplary kidney stone collector 500 that accommodates a urine splashguard 530, in accordance with an embodiment of the present invention. In the present embodiment, the top of a frame 515 comprises four slits 535 with two slits 535 on each long side of frame 515. A pliable piece of plastic with two tabs 540 extending from the bottom acts as splashguard 530. In typical use of the present embodiment, a user slightly squeezes splashguard 530 and inserts tabs 540 into the desired slits 535. When tabs 540 of splashguard 530 are inserted, splashguard 530 extends straight upward to guard against urine splashing back upon the user. The present embodiment comprises four slits 535, one set of two on each side of frame 515, to accommodate left handed and right handed users. Alternate embodiments may be implemented as left handed or right handed devices with slits only on one side. The present embodiment may be beneficial for men as they typically stand while urinating causing distance from the tip of the penis and kidney stone collector 500 and this distance can cause the urine to splash. Splashguard 530 generally prevents urine from soiling the user. Those skilled in the art, in light of the present teachings, will readily recognize that splashguards in alternate embodiments may be attached to kidney stone collectors using various different means such as, but not limited to, adhesive tabs, clips, pegs, etc. Other alternate embodiments may be permanently integrated into the frame of the kidney stone collector so they are not detachable. Furthermore, splashguards in alternate embodiments may be made of various different materials including, but not limited to, paper, or cardboard. Paper splashguards may have the benefit of being flushable.

Having fully described at least one embodiment of the present invention, other equivalent or alternative methods of providing kidney stone collectors according to the present invention will be apparent to those skilled in the art. The invention has been described above by way of illustration, and the specific embodiments disclosed are not intended to limit the invention to the particular forms disclosed. For example, the particular implementation of the kidney stone collectors may vary depending upon the particular type of materials used. The kidney stone collectors described in the foregoing were directed to disposable implementations; however, similar techniques are to provide kidney stone collectors that are not meant to be disposable. For example, without limitation, some alternate embodiments may be made of materials that may be sterilized such as, but not limited to, stainless steel so that they may be used multiple times. Furthermore, non-disposable embodiments may comprise additional features that may not be found on disposable embodiments such as, but not limited to, cushioned handles, lids, storage hooks, etc. Non-disposable implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
a frame comprising a top side, a bottom side and a generally oval shape;
means joined to said bottom side for freely passing urine and collecting stones; and
means joined to said frame for holding said passing and collecting means while urinating, and for a user to avoid contacting the urine.

2. The apparatus as recited in claim 1, further comprising means for joining said elongated handle to said frame.

3. The apparatus as recited in claim 2, further comprising means joined to said holding means for insertion into said joining means.

4. The apparatus as recited in claim 1, further comprising means joined to said top for mitigating splash back upon the user.

5. An apparatus comprising:
a frame comprising a top side, a bottom side and a generally oval shape;
a mesh net joined to, and being suspended below, said bottom side, said mesh net comprising a sufficient porosity for freely passing urine and collecting stones in said mesh net; and
an elongated handle joined to said frame for holding said mesh net while urinating, and for a user to avoid contacting the urine.

6. The apparatus as recited in claim 5, wherein said mesh net forms a semi-circular shape.

7. The apparatus as recited in claim 5, further comprising a protruding stem joined to said frame for joining said elongated handle to said frame.

8. The apparatus as recited in claim 7, wherein said protruding stem is hollow.

9. The apparatus as recited in claim 8, further comprising an extending bulb joined to a distal end of said elongated handle for insertion into said protruding stem.

10. The apparatus as recited in claim 5, wherein said elongated handle is removable.

11. The apparatus as recited in claim 5, wherein said elongated handle comprises an ergonomic design for facilitating use of the apparatus while sitting.

12. The apparatus as recited in claim 11, wherein said elongated handle comprises an arched shape.

13. The apparatus as recited in claim 5, further comprising a splashguard joined to said top for mitigating splash back upon the user.

14. The apparatus as recited in claim 13, wherein said splashguard extends upward from said top about a portion of said top.

15. The apparatus as recited in claim 14, wherein said portion is selected for right or left handed use of the apparatus.

16. The apparatus as recited in claim 13, wherein said top further comprises slots and said splashguard further comprises tabs for joining to said slots.

17. The apparatus as recited in claim 16, wherein said splashguard is removable.

18. An apparatus comprising:
a frame comprising a top side comprising slots, a bottom side and a generally oval shape;
a hollow protruding stem joined to said frame;
a mesh net joined to, and being suspended below, said bottom side, said mesh net comprising a semi-circular shape with a sufficient porosity for freely passing urine and collecting stones in said mesh net;
an elongated handle for holding said mesh net while urinating, and for a user to avoid contacting the urine, said elongated handle comprising an ergonomic design having an arched shape for facilitating use of the apparatus while sitting;
an extending bulb joined to a distal end of said elongated handle for insertion into said protruding stem; and
a splashguard comprising tabs for joining to said slots and extending upward from said top about a portion of said top for mitigating splash back upon the user, wherein said portion is selected for right or left handed use of the apparatus.

19. The apparatus as recited in claim 18, wherein said elongated handle is removable.

20. The apparatus as recited in claim 18, wherein said splashguard is removable.
